(19) United States
(12) Patent Application Publication
(10) Pub. No.: US 2023/0354787 A1
(43) Pub. Date: Nov. 9, 2023

(54) HEAT STRESS RESISTING TECHNOLOGY FOR TRANSPORT OF LIVE FISH

(71) Applicant: Agro-product Processing and Nuclear Agricultural Institute, HAAS, Wuhan (CN)

(72) Inventors: Tao Liao, Wuhan (CN); Liang Qiu, Wuhan (CN); Juguang Wang, Wuhan (CN); Chan Bai, Wuhan (CN); Guangquan Xiong, Wuhan (CN); Xiaoyan Zu, Wuhan (CN); Hailan Li, Wuhan (CN); Shengrong Geng, Wuhan (CN)

(21) Appl. No.: 18/354,755

(22) Filed: Jul. 19, 2023

(30) Foreign Application Priority Data
Jul. 25, 2022 (CN) 202210875749.5

(51) Int. Cl. A01K 63/04; A01K 63/02; A01K 63/06

(52) U.S. Cl. CPC A01K 63/02; A01K 63/042; A01K 63/065

(57) ABSTRACT

The present invention relates to a heat stress resisting technology for transport of live fish. Display screens are arranged in a transport case on the four side surfaces and the top surface, a plurality of transparent interlayer trays are arranged in the fish tank from the bottom to the top, a plurality of small through holes are formed in the interlayer trays, an oxygen generator is arranged in the transport case, an oxygen content meter is arranged in a pipeline of the oxygen generator, a refrigeration system is arranged in the transport case on one side surface, an air exchange pipe is arranged in the fish tank, the air exchange pipe extends out of the transport case, a second solenoid valve is arranged in the air exchange pipe. The present invention makes fish have no swimming activity and lack of response to external stimuli.

### TECHNICAL FIELD

The present invention relates to the technical field of aquaculture, and in particular to a heat stress resisting technology for transport of live fish.

### BACKGROUND

The most common disease in aquaculture is fish stress hemorrhagic disease which is easy to be induced especially in the stress conditions such as net hauling in, pool assignment, case transfer and long-distance transport. The disease can result in the death of a large number of fish, and the incidence rate of the disease can be as high as 20%-40%.

Aquatic products can be transported by water, land and air. In principle, methods for improving the survival rate of aquatic products during transport are divided into two kinds:

The first is to reduce the metabolic intensity of transported live aquatic products (by means of conducting physicochemical anesthesia, reducing the temperature of water and transported live aquatic products, and reducing the stress response thereof).

The second is to improve the water quality environment of the water used for live transport (by means of supplying oxygen and adding various buffer systems, bacteriostatic agents, antifoaming agents and zeolite).

In the existing first fish transport technology, i.e., to reduce the metabolic intensity of transported live aquatic products, anesthetic-assisted transport means that an anesthetic is used to make fish quickly enter a dormant state before or during transport, thus to reduce the activity and the metabolism of the aquatic products, thereby increasing the survival rate of the fish during transport. However, the technology is not suitable for the transport of organic fish because chemical drugs may cause the problem of drug residue. On this basis, a new technology is proposed.

### SUMMARY

In order to solve the above technical problems, the present invention provides a heat stress resisting technology for transport of live fish.

To solve the above technical problems, the present invention provides the following technical solution: a heat stress resisting technology for transport of live fish, comprising a carriage on an existing transport vehicle, i.e., a transport case, wherein display screens are arranged in the transport case on the four side surfaces and the top surface, a transparent fish tank is arranged in the transport case on the bottom surface, the upper end of the fish tank is provided with an opening, a plurality of transparent interlayer trays are arranged in the fish tank from the bottom to the top, a plurality of small through holes are formed in the interlayer trays, an existing oxygen generator commonly used for supplying oxygen to fish is arranged in the transport case on an outer side surface of the fish tank, an output end of the oxygen generator is in communication with a pipeline, an air outlet pipe is arranged on an inner side surface of the fish tank, a plurality of small air outlet holes are distributed in the outer side surface of the air outlet pipe, one end of the air outlet pipe extending out of the fish tank is in communication with the pipeline, an oxygen content meter is arranged in the pipeline, a refrigeration system is arranged in the transport case on one side surface, a cold air outlet of the refrigeration system is in communication with a delivery pipe, a hot gas outlet of the refrigeration system is in communication with an exhaust pipe, the refrigeration system can be a refrigeration system of an air conditioner commonly used for regulating the temperature of a gas, including a refrigeration system composed of a cold exchange valve, a cold-heat exchanger, a heat exchange valve and relevant pipelines, a free end of the exhaust pipe extends out of the transport case, a first solenoid valve is arranged on the exhaust pipe, the delivery pipe extends into the fish tank, an air exchange pipe is arranged in the fish tank, the air exchange pipe extends out of the transport case, a second solenoid valve is arranged in the air exchange pipe, a plurality pots of aquatic plants are arranged on the interlayer trays, a natural anti-stress solution is contained in the fish tank, a temperature detector is arranged in the fish tank, and a monitor is arranged in the fish tank at a position close to the upper end.

As an improvement, sound equipment is arranged in the transport case on the four side surfaces, which can create a more authentic undersea or underwater world.

As an improvement, one end of the air exchange pipe located in the fish tank is close to the upper end of the fish tank.

Preferably, the anti-stress solution comprises the following parts by weight of components: 10 parts of clove essential oil, 10 parts of isoeugenol, 10 parts of eugenol, 70 parts of food-grade β-cyclodextrin, 100 parts of fresh water and 150 parts of crushed ice water.

As an improvement, the weight of the anti-stress solution is half the weight of the fish transported.

After adopting the above structure, the present invention has the following advantages: the anti-stress solution is added into the fish tank, then an appropriate number of fish are put into each space separated by the interlayer trays, and ten minutes later, the refrigeration system is started to reduce the temperature of the fish tank, thus the fish are kept alive at a low temperature; during transport, a temperature control mode is adopted to make the fish live in a semi-dormant or completely dormant state, so as to reduce metabolism, reduce mechanical damage and prolong survival time, thus the purpose of long-distance transport is achieved; in addition, as the anti-stress solution contains a natural anesthetic, only a small amount of chemical components is needed to take effect in a relatively short time to make the fish have no swimming activity and lack of response to external stimuli, so no stress response will appear, and losses are reduced; such a small amount of natural anesthetic will not cause the problem of chemical residue, and will not harm the fish; and even if a larger amount of natural anesthetic is inhaled, the anesthetic is easy to be absorbed and metabolized by the body because of the food-grade β-cyclodextrin.

### DESCRIPTION OF DRAWINGS

FIG. 1 is a front structural schematic diagram of a heat stress resisting technology for transport of live fish of the present invention.

FIG. 2 is a top structural schematic diagram of a heat stress resisting technology for transport of live fish of the present invention.

In the figures: 1. transport case, 2. fish tank, 3. interlayer tray, 4. small through hole, 5. oxygen generator, 6. pipeline, 7. air outlet pipe, 8. small air outlet hole, 9. oxygen content meter, 10. refrigeration system, 11. delivery pipe, 12. exhaust pipe, 13. first solenoid valve, 14. air exchange pipe, 15. second solenoid valve, 16. pot of aquatic plant, 17. temperature detector, 18. monitor, 19. sound equipment, and 20. display screen.

### DETAILED DESCRIPTION

The present invention will be further described in detail below in combination with the drawings.

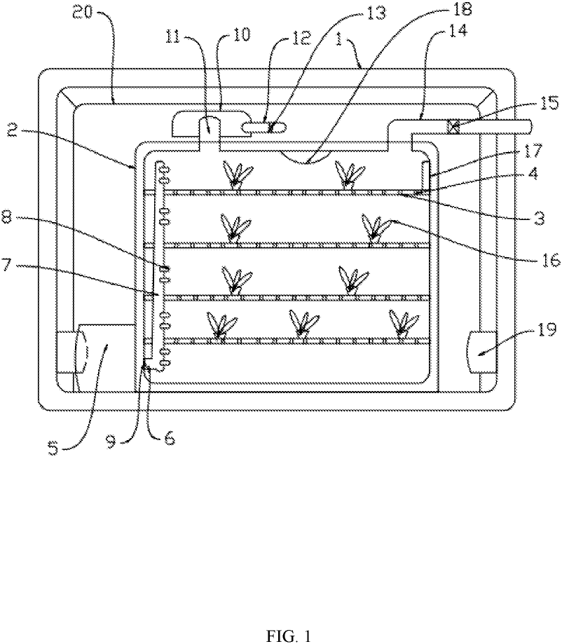

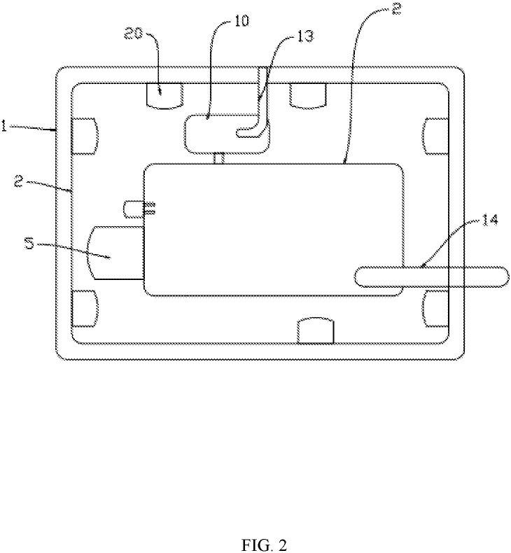

Referring to FIG. 1 and FIG. 2, a heat stress resisting technology for transport of live fish, comprising a carriage on an existing transport vehicle, i.e., a transport case, wherein display screens 20 are arranged in the transport case 1 on the four side surfaces and the top surface, a transparent fish tank 2 is arranged in the transport case 1 on the bottom surface, the upper end of the fish tank is provided with an opening, a plurality of transparent interlayer trays 3 are arranged in the fish tank 2 from the bottom to the top, a plurality of small through holes 4 are formed in the interlayer trays 3, an existing oxygen generator 5 commonly used for supplying oxygen to fish is arranged in the transport case 1 on an outer side surface of the fish tank 2, an output end of the oxygen generator 5 is in communication with a pipeline 6, an air outlet pipe 7 is arranged on an inner side surface of the fish tank 2, a plurality of small air outlet holes 8 are distributed in the outer side surface of the air outlet pipe 7, the space in the air outlet pipe is gradually reduced from the top to the bottom, which is favorable for the uniform dissipation of oxygen from the small air outlet holes, one end of the air outlet pipe 7 extending out of the fish tank 2 is in communication with the pipeline 6, an oxygen content meter 9 is arranged in the pipeline 6, a refrigeration system 10 is arranged in the transport case 1 on one side surface, a cold air outlet of the refrigeration system 10 is in communication with a delivery pipe 11, a hot gas outlet of the refrigeration system 10 is in communication with an exhaust pipe 12, the refrigeration system can be a refrigeration system of an air conditioner commonly used for regulating the temperature of a gas, including a refrigeration system composed of a cold exchange valve, a cold-heat exchanger, a heat exchange valve and relevant pipelines, a free end of the exhaust pipe 12 extends out of the transport case 1, a first solenoid valve 13 is arranged on the exhaust pipe 12, the delivery pipe 11 extends into the fish tank 2, an air exchange pipe 14 is arranged in the fish tank 2, the air exchange pipe 14 extends out of the transport case 1, a second solenoid valve 15 is arranged in the air exchange pipe 14, a plurality pots of aquatic plants 16 are arranged on the interlayer trays 3, a natural anti-stress solution is contained in the fish tank 2, a temperature detector 17 is arranged in the fish tank 2, a monitor 18 is arranged in the fish tank 2 at a position close to the upper end, and the weight of the anti-stress solution is half the weight of the fish transported.

Sound equipment 19 is arranged in the transport case 1 on the four side surfaces, which can create a more authentic undersea or underwater world.

One end of the air exchange pipe 14 located in the fish tank 2 is close to the upper end of the fish tank 2.

The anti-stress solution comprises the following parts by weight of components: 10 parts of clove essential oil, 10 parts of isoeugenol, 10 parts of eugenol, 70 parts of food-grade β-cyclodextrin, 100 parts of fresh water and 150 parts of crushed ice water, and the clove essential oil, the isoeugenol or the eugenol can also be replaced with single essential oil, isoeugenol or eugenol.

In a concrete implementation process of the present invention, the display screens arranged are convenient for displaying an undersea or underwater scene, and the sound equipment is used for playing undersea or underwater sounds, which are integrated to disturb the fish, as if the fish are living in the original water, and give the fish an immersive experience; the anti-stress solution is added into the fish tank, then an appropriate number of fish are put into each space separated by the interlayer trays, and ten minutes later, the refrigeration system is started to reduce the temperature of the fish tank, thus the fish are kept alive at a low temperature; during transport, a temperature control mode is adopted to make the fish live in a semi-dormant or completely dormant state, so as to reduce metabolism, reduce mechanical damage and prolong survival time, thus the purpose of long-distance transport is achieved; in addition, as the anti-stress solution contains a natural anesthetic, only a small amount of chemical components is needed to take effect in a relatively short time to make the fish have no swimming activity and lack of response to external stimuli, so no stress response will appear, and losses are reduced; such a small amount of natural anesthetic will not cause the problem of chemical residue, and will not harm the fish; and even if a larger amount of natural anesthetic is inhaled, the anesthetic is easy to be absorbed and metabolized by the body because of the food-grade β-cyclodextrin.

The sound equipment, the display screens, the refrigeration system, the first solenoid valve, the second solenoid valve, the third solenoid valve, the oxygen generator, the oxygen content meter, the temperature detector and the monitor are electrically connected with a control terminal, and the electrical appliances are controlled by the control terminal, which is to control whether the oxygen generator generates oxygen, control the opening or closing of the first solenoid valve, the second solenoid valve and the third solenoid valve, and control whether the display screens play videos or what kind of videos are played; and the conditions of the fish and the temperature in the fish tank are known through the temperature detector and the monitor.

The present invention has the following operating principle: in order to increase the water solubility of clove essential oil and the absorption thereof by fish, thus improving the anesthetic effect thereof, the essential oil can be used in combination with food-grade β-cyclodextrin; food-grade β-cyclodextrin can improve the therapeutic response of an analgesic drug, and cyclodextrins can be found in at least 35 pharmaceutical products used as anticancer agents or analgesic and anti-inflammatory drugs for use in human body. This is consistent with the findings of several studies. The studies show that compared with a single drug, drugs in the form of inclusion complexes with cyclodextrins may be beneficial to the human in terms of solubility, stability and ability to improve the pharmacological responses. Therefore, eating fish that have the anti-stress solution in body is also beneficial to human body.

The formation of inclusion complexes between food-grade β-cyclodextrin and different molecules has been extensively studied in literatures. In this way, the behavior of the molecules is successfully altered, for example by making the molecules more soluble in water. Food-grade β-cyclodextrin consists of a group of natural annular oligosaccharides derived from starch, in which six, seven or eight glucose molecules are combined via α(1-4) glycosidic bonds to form cylindrical structures called α-, β- and γ-cyclodextrins; The central cavities of the molecules are hydrophobic, the outer edge of the wall surrounding each cavity is hydrophilic, and inclusion complexes are formed by the hydrophobic cavities with a variety of organic host molecules. Food-grade β-cyclodextrin can be considered as a nanoencapsulation agent, and the formation of cyclodextrin-host complexes is equivalent to molecular encapsulation because the host molecules are separated from each other and dispersed in oligosaccharide matrix at molecular level.

The present invention and the embodiment thereof are described above. The description is not restrictive, and the actual structure is not limited thereto. To sum up, any structure and embodiment similar to the technical solution of the present invention designed by those ordinary skilled in the art under the enlightenment of the present invention without departing from the purpose of the present invention and without making any creative contribution shall fall into the protection scope of the present invention.

What is claimed is:

1. A heat stress resisting technology for transport of live fish, comprising a transport case (1), wherein display screens (20) are arranged in the transport case (1) on the four side surfaces and the top surface, a transparent fish tank (2) is arranged in the transport case (1) on the bottom surface, a plurality of transparent interlayer trays (3) are arranged in the fish tank (2) from the bottom to the top, a plurality of small through holes (4) are formed in the interlayer trays (3), an oxygen generator (5) is arranged in the transport case (1) on an outer side surface of the fish tank (2), an output end of the oxygen generator (5) is in communication with a pipeline (6), an air outlet pipe (7) is arranged on an inner side surface of the fish tank (2), a plurality of small air outlet holes (8) are distributed in the outer side surface of the air outlet pipe (7), one end of the air outlet pipe (7) extending out of the fish tank (2) is in communication with the pipeline (6), an oxygen content meter (9) is arranged in the pipeline (6), a refrigeration system (10) is arranged in the transport case (1) on one side surface, a cold air outlet of the refrigeration system (10) is in communication with a delivery pipe (11), a hot gas outlet of the refrigeration system (10) is in communication with an exhaust pipe (12), a free end of the exhaust pipe (12) extends out of the transport case (1), a first solenoid valve (13) is arranged on the exhaust pipe (12), the delivery pipe (11) extends into the fish tank (2), an air exchange pipe (14) is arranged in the fish tank (2), the air exchange pipe (14) extends out of the transport case (1), a second solenoid valve (15) is arranged in the air exchange pipe (14), a plurality pots of aquatic plants (16) are arranged on the interlayer trays (3), a natural anti-stress solution is contained in the fish tank (2), a temperature detector (17) is arranged in the fish tank (2), and a monitor (18) is arranged in the fish tank (2) at a position close to the upper end.

2. The heat stress resisting technology for transport of live fish according to claim 1, wherein sound equipment (19) is arranged in the transport case (1) on the four side surfaces.

3. The heat stress resisting technology for transport of live fish according to claim 1, wherein one end of the air exchange pipe (14) located in the fish tank (2) is close to the upper end of the fish tank (2).

4. The heat stress resisting technology for transport of live fish according to claim 1, wherein the anti-stress solution comprises the following parts by weight of components: 10 parts of clove essential oil, 10 parts of isoeugenol, 10 parts of eugenol, 70 parts of food-grade β-cyclodextrin, 100 parts of fresh water and 150 parts of crushed ice water.

5. The heat stress resisting technology for transport of live fish according to claim 4, wherein the weight of the anti-stress solution is half the weight of the fish transported.
